(19) United States
(12) Patent Application Publication
(10) Pub. No.: US 2012/0220709 A1
(43) Pub. Date: Aug. 30, 2012

(54) POLYCARBONATE RESIN COMPOSITION, POLYCARBONATE RESIN MOLDED ARTICLE, AND MANUFACTURING METHOD THEREFOR

(75) Inventor: Takayoshi Tanaka, Chiba (JP)

(73) Assignee: IDEMITSU KOSAN CO., LTD., Tokyo (JP)

(21) Appl. No.: 13/504,819

(22) PCT Filed: Oct. 29, 2010
(86) PCT No.: PCT/JP2010/069333

§ 371 Date: Apr. 27, 2012

(30) Foreign Application Priority Data
Oct. 30, 2009 (JP) 2009-250998

(51) Int. Cl. C08L 69/00; C08K 3/40; C08K 3/08; B29C 45/00

(52) U.S. Cl. 524/441; 264/328.1; 524/494

(57) ABSTRACT

Provided are: a polycarbonate resin composition, including, with respect to 100 parts by mass of a glass fiber-containing resin component formed of 60 to 90 mass % of (A) an aromatic polycarbonate resin, 5 to 20 mass % of (B) such glass fibers that a difference in refractive index between the aromatic polycarbonate resin and each of the fibers is 0.02 or less, and 5 to 25 mass % of (C) a polymethyl methacrylate resin, (D) 0.005 to 1.5 parts by mass of (D-1) glossy particles having an average particle diameter of 10 μm or more and less than 60 μm, and 0.005 to 5 parts by mass of (D-2) glossy particles having an average particle diameter of 60 to 300 μm, and 0.05 to 0.4 part by mass of (E) titanium oxide having an average particle diameter of 0.05 to 3 μm; a resin molded article obtained by molding the resin composition; and a method of producing the resin molded article. The polycarbonate resin composition is capable of providing a molded article having reduced visibility of a weld line fusion portion, no visible difference in luminosity between the left and right sides of a weld line, and a good metallic or galactic appearance, the composition being excellent in heat resistance and mechanical properties.

### TECHNICAL FIELD

The present invention relates to a polycarbonate resin composition, a polycarbonate resin molded article using the composition, and a method of producing the resin molded article, more specifically, to a polycarbonate resin composition suitable for a structural member field where a design appearance is requested such as a television, refrigerator, or cleaner having, for example, a metallic appearance or a galactic appearance while taking advantage of the heat resistance and mechanical properties of a polycarbonate, a polycarbonate resin molded article obtained by molding the resin composition, and a method of producing the resin molded article.

### BACKGROUND ART

Polycarbonate resin molded articles have been widely used as, for example, industrial transparent materials in the fields of electrical and electronic engineering, mechanical engineering, automobiles, and the like or optical materials for lenses, optical disks, and the like because each of the articles is excellent in transparency, heat resistance, and mechanical properties.

In addition, it has been known that a glass filler and the like are added when additionally high mechanical properties are needed in the polycarbonate resin molded article, and glossy particles and the like are added when a high degree of design appearance such as a metallic appearance or a galactic appearance (such an appearance that the entirety sparkles like the night sky studded with stars) is needed in the molded article.

However, when an E-glass to be generally used as the glass filler is added, transparency cannot be obtained owing to a difference in refractive index. In addition, when a polycarbonate resin composition to which the glossy particles have been added is subjected to resin molding, a weld line occurs at a portion where molten resins merge with each other to be welded. Accordingly, a fusion line, and a difference in luminosity between the left and right sides with respect to the fusion line (the orientations of the glossy particles) occur. As a result, the value of the molded article as a commercial product drastically reduces.

For example, (1) a resin composition containing a polycarbonate resin composition using a product of a reaction between a hydroxyaralkyl alcohol and lactone as a terminal stopper and a glass filler having a difference in refractive index from the polycarbonate resin composition of 0.01 or less (see Patent Document 1), (2) a resin composition formed of a polycarbonate resin, a glass filler having a difference in refractive index from the polycarbonate resin of 0.015 or less, and polycaprolactone (see Patent Document 2), and (3) a glass composition obtained by incorporating, for example, ZrO₂, TiO₂, BaO, and ZnO into a glass filler composition at a specific ratio so that the refractive index of the composition is close to that of a polycarbonate resin (see Patent Document 3) have been proposed as a polycarbonate resin composition which contains a glass filler and in which an investigation has been conducted on the improvement in transparency.

In the cases of Patent Literatures 1 to 3, however, there is no description concerning the problem, i.e., the reduction of the weld line and the orientations of the glossy particles.

In addition, for example, (4) a resin composition containing, as glossy particles, particles having an average particle diameter of 10 to 300 μm and each having a shape with an aspect ratio of 1/8 to 1 (see Patent Literature 4) and (5) a resin composition containing, as glossy particles, metal fine particles each of which is a quadrangle and is provided with a notch in one of its corners (see Patent Literature 5) have each been proposed as a polycarbonate resin composition which contains glossy particles and in which an investigation has been conducted on the improvement in transparency.

However, a sufficiently satisfactory composition cannot be obtained in reliance only on the shapes of the glossy particles themselves like Patent Literatures 4 and 5 from the viewpoint of not only, of course, the suppression of the occurrence of the weld line but also the reduction of the difference in luminosity between the left and right sides with respect to the weld line.

### PATENT LITERATURE

[PTL 1] JP 07-118514 A

[PTL 2] JP 09-165506 A

[PTL 3] JP 05-155638 A

[PTL 4] JP 06-99594 B

[PTL 5] JP 07-53768 A

### SUMMARY OF INVENTION

### Problem to be Solved by the Invention

An object of the present invention is to provide a polycarbonate resin composition capable of providing a molded article having reduced visibility of a weld line fusion portion, no visible difference in luminosity between the left and right sides of a weld line, and a good metallic or galactic appearance, the composition being excellent in heat resistance and mechanical properties, a polycarbonate resin molded article obtained by molding the resin composition, and a method of producing the resin molded article.

### Solution to Problem

The inventors of the present invention have made extensive studies, and as a result, have found that the object can be achieved with a polycarbonate resin composition obtained by incorporating, into a glass fiber-containing resin component formed of an aromatic polycarbonate resin, such glass fibers that a difference in refractive index between the aromatic polycarbonate resin and each of the fibers falls within a specific range, and a polymethyl methacrylate resin, two kinds of glossy particles having different particle diameter ranges and titanium oxide having a specific average particle diameter each at a predetermined ratio, a polycarbonate resin molded article obtained by molding the resin composition, and a method of producing the resin molded article. The present invention has been completed on the basis of such finding.

That is, the present invention provides the following polycarbonate resin composition, a polycarbonate resin molded article obtained by molding the resin composition, and a method of producing the resin molded article.

1. A polycarbonate resin composition, comprising, with respect to 100 parts by mass of a glass fiber-containing resin component formed of 60 to 90 mass % of (A) an aromatic polycarbonate resin, 5 to 20 mass % of (B) such glass fibers that a difference in refractive index between the aromatic polycarbonate resin and each of the fibers is 0.02 or less, and 5 to 25 mass % of (C) a polymethyl methacrylate resin, (D) 0.005 to 1.5 parts by mass of (D-1) glossy particles having an average particle diameter of 10 μm or more and less than 60 μm, and 0.005 to 5 parts by mass of (D-2) glossy particles having an average particle diameter of 60 to 300 μm, and 0.05 to 0.4 part by mass of (E) titanium oxide having an average particle diameter of 0.05 to 3 μm.

2. The polycarbonate resin composition according to the item 1, wherein the composition contains 10 to 80 mass % of a polycarbonate-polyorganosiloxane copolymer as the component (A) in the glass fiber- containing resin component formed of the component (A), the component (B), and the component (C).

3. The polycarbonate resin composition according to the item 2, wherein a content of a polyorganosiloxane portion in the polycarbonate-polyorganosiloxane copolymer is 0.3 to 5 mass %.

4. The polycarbonate resin composition according to any one of the items 1 to 3, wherein the glass fibers as the component (B) each have a refractive index of 1.583 to 1.587.

5. The polycarbonate resin composition according to the item 1 or 4, wherein the glossy particles as the component (D) include one kind or two or more kinds selected from the group consisting of mica, metal particles, metal sulfide particles, particles each having a surface coated with a metal or a metal oxide, and glass flakes each having a surface coated with a metal or a metal oxide.

6. The polycarbonate resin composition according to any one the items 1 to 5, wherein a mass ratio between the component (D-1) and the component (D-2) in the component (D) is 1:1 to 1:7.

7. The polycarbonate resin composition according to any one of the items 1 to 6, further including 0.0001 to 1 part by mass of (F) a colorant with respect to 100 parts by mass of the glass fiber-containing resin component formed of the component (A), the component (B), and the component (C).

8. The polycarbonate resin composition according to the item 7, wherein the colorant as the component (F) includes aluminum powder particles.

9. The polycarbonate resin composition according to the item 8, wherein the aluminum powder particles have an average particle diameter of 30 to 80 μm.

10. A polycarbonate resin molded article obtained by molding the polycarbonate resin composition according to any one of the items 1 to 9.

11. The polycarbonate resin molded article according to the item 10, wherein the polycarbonate resin molded article is obtained by injection molding at a mold temperature of 120° C. or more.

12. A method of producing a polycarbonate resin molded article, comprising subjecting the polycarbonate resin composition according to any one of the items 1 to 9 to injection molding at a mold temperature of 120° C. or more.

### Advantageous Effects of Invention

According to the present invention, there can be provided a polycarbonate resin composition having excellent heat resistance and excellent mechanical properties. In addition, the resin composition can promote a metallic feeling-expressing effect because the composition contains a polymethyl methacrylate resin. Further, a molded article obtained by using the resin composition has reduced visibility of a weld line fusion portion, no visible difference in luminosity between the left and right sides of a weld line, and an excellent metallic or galactic appearance because the content of its glossy particles considered to be responsible for the occurrence of the weld line can be reduced. Further, according to the present invention, there can also be provided a production method by which the molded article can be obtained.

### DESCRIPTION OF EMBODIMENTS

[Polycarbonate Resin Composition]

A polycarbonate resin composition of the present invention contains, as essential components, (A) an aromatic polycarbonate resin, (B) such glass fibers that a difference in refractive index between the aromatic polycarbonate resin and each of the fibers is 0.02 or less, (C) a polymethyl methacrylate resin, (D) glossy particles including (D-1) glossy particles having an average particle diameter of 10 μm or more and less than 60 μm, and (D-2) glossy particles having an average particle diameter of 60 to 300 μm, and (E) titanium oxide having an average particle diameter of 0.05 to 3 μm.

((A) Aromatic Polycarbonate Resin)

In the polycarbonate resin composition of the present invention, an aromatic polycarbonate resin produced by a reaction between a dihydric phenol and a carbonate precursor can be specifically used as the aromatic polycarbonate resin as the component (A).

A method of producing the aromatic polycarbonate resin as the component (A) is not particularly limited, and resins produced by various conventional methods can each be used as the resin. For example, a resin produced from a dihydric phenol and a carbonate precursor by a solution method (interfacial polycondensation method) or a melt method (ester exchange method), that is, a resin produced by, for example, an interfacial polycondensation method involving causing the dihydric phenol and phosgene to react with each other in the presence of a terminal stopper or an ester exchange method involving causing the dihydric phenol and diphenyl carbonate or the like to react with each other in the presence of a terminal stopper can be used.

As the dihydric phenol, various examples are given. In particular, examples thereof include 2,2-bis(4-hydroxyphenyl)propane (bisphenol A), bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cycloalkane, bis(4-hydroxyphenyl)oxide, bis(4-hydroxyphenyl)sulfide, bis(4-hydroxyphenyl)sulfone, bis(4-hydroxyphenyl)sulfoxide, and bis(4-hydroxyphenyl)ketone. In addition, hydroquinone, resorcin, and catechol can be also exemplified. One kind of those dihydric phenols may be used alone, or two or more kinds thereof may be used in combination. Of those, bis(hydroxyphenyl)alkanes are preferred, and bisphenol A is particularly preferred.

On the other hand, as the carbonate precursor, a carbonyl halide, a carbonyl ester, a haloformate, and the like are given. Specifically, phosgene, a dihaloformate of a dihydric phenol, diphenyl carbonate, dimethyl carbonate, and diethyl carbonate are given.

It should be noted that the aromatic polycarbonate resin may have a branched structure. As a branching agent, 1,1,1-tris(4-hydroxyphenyl)ethane, α,α′,α″-tris(4-hydroxyphenyl)-1,3,5-triisopropylbenzene, phloroglucin, trimellitic acid, and isatin bis(o-cresol) are exemplified.

In the present invention, a viscosity-average molecular weight (Mv) of the component (A) is generally 10,000 to 50,000, preferably 13,000 to 35,000, more preferably 15,000 to 20,000.

The viscosity-average molecular weight (Mv) is calculated by the following equation, after a limiting viscosity [η] is obtained by determining a viscosity of a methylene chloride solution at 20° C. by using a Ubbelohde type viscometer.

[η]=1.23×10⁻⁵Mv^{0.83}

A molecular terminal group in (A) the aromatic polycarbonate resin is not particularly limited, and a monovalent, phenol-derived group as a conventionally known terminal stopper may be used; a monovalent, phenol-derived group having an alkyl group having 10 to 35 carbon atoms is preferred. When the molecular terminal is a phenol-derived group having an alkyl group having 10 or more carbon atoms, a polycarbonate resin composition to be obtained has good flowability. In addition, when the molecular terminal is a phenol-derived group having an alkyl group having 35 or less carbon atoms, the polycarbonate resin composition to be obtained has good heat resistance and good impact resistance.

Examples of the monovalent phenol having an alkyl group having 10 to 35 carbon atoms include decyl phenol, undecyl phenol, dodecyl phenol, tridecyl phenol, tetradecyl phenol, pentadecyl phenol, hexadecyl phenol, heptadecyl phenol, octadecyl phenol, nonadecyl phenol, icosyl phenol, docosyl phenol, tetracosyl phenol, hexacosyl phenol, octacosyl phenol, triacontyl phenol, dotriacontyl phenol, and pentatriacontyl phenol.

The alkyl group may be present at any one of the o-, m-, and p-positions of each of those alkyl phenols with respect to the hydroxy group; the alkyl group is preferably present at the p-position. In addition, the alkyl group may be a linear group, a branched group, or a mixture of them.

At least one substituent of each of the alkyl phenols has only to be the alkyl group having 10 to 35 carbon atoms, and the other four substituents are not particularly limited; each of the other four substituents may be an alkyl group having 1 to 9 carbon atoms, an aryl group having 6 to 20 carbon atoms, or a halogen atom, or each of the alkyl phenols may be unsubstituted except for the hydroxy group and the alkyl group having 10 to 35 carbon atoms.

Only one of the terminals of the polycarbonate resin may be sealed with a monovalent phenol having the alkyl group having 10 to 35 carbon atoms, or each of both the terminals may be sealed with the phenol. In addition, terminals each denatured with the phenol account for preferably 20% or more, more preferably 50% or more of all terminals from the viewpoint of an improvement in flowability of the polycarbonate resin composition to be obtained. That is, the other terminals none of which is sealed with the phenol may each be sealed with a hydroxy group terminal or any one of the other terminal stoppers in the following description.

Here, examples of the other terminal stoppers include phenol, p-cresol, p-tert-butylphenol, p-tert-octylphenol, p-cumylphenol, p-nonylphenol, p-tert-amylphenol, bromophenol, tribromophenol, and pentabromophenol, which are commonly used in the production of the aromatic polycarbonate resin. Of those, a halogen-free compound is preferred in view of environmental issues.

In addition, an aromatic polycarbonate resin containing a polycarbonate-polyorganosiloxane copolymer (hereinafter, sometimes abbreviated as “PC-POS copolymer”) is preferably used as the component (A) of the present invention.

Specifically, the content of the polycarbonate-polyorganosiloxane copolymer in the glass fiber-containing resin component formed of the component (A), the component (B), and the component (C) is preferably 10 to 80 mass %. When the content is 10 mass % or more, a polycarbonate resin composition having good rigidity can be obtained. When the content is 80 mass % or less, a polycarbonate resin composition whose specific gravity is not excessively large and which has good impact resistance can be obtained.

The PC-POS copolymer is formed of a polycarbonate portion and a polyorganosiloxane portion, and can be produced, for example, as described below. A polycarbonate oligomer (hereinafter abbreviated as “PC oligomer”) for constructing the polycarbonate portion produced in advance and a polyorganosiloxane having a reactive group such as an o-allylphenol residue, a p-hydroxystyrene residue, or a eugenol residue at a terminal thereof for constructing the polyorganosiloxane portion (segment) are dissolved in a solvent such as methylene chloride, chlorobenzene, or chloroform, and then a caustic alkali aqueous solution of a dihydric phenol is added to the solution. The mixture is subjected to an interfacial polycondensation reaction with a tertiary amine (such as triethylamine) or a quaternary ammonium salt (such as trimethylbenzylammonium chloride) as a catalyst in the presence of a terminal stopper.

The PC oligomer to be used in the production of the PC-POS copolymer can be easily produced as described below. The dihydric phenol and a carbonate precursor such as phosgene are caused to react with each other in a solvent such as methylene chloride. Alternatively, the dihydric phenol and a carbonate precursor like a carbonate compound such as diphenyl carbonate are caused to react with each other.

In addition, diaryl carbonates such as diphenyl carbonate, and dialkyl carbonates such as dimethyl carbonate and diethyl carbonate can be given as examples of the carbonate compound.

The PC oligomer to be used in the production of the PC-POS copolymer may be a homooligomer using one kind of the dihydric phenol, or may be a co-oligomer using two or more kinds of the dihydric phenols.

Further, the PC oligomer maybe a thermoplastic, randomly branched oligomer obtained by using a polyfunctional aromatic compound in combination with the dihydric phenol.

In such a case, 1,1,1-tris(4-hydroxyphenyl)ethane, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benzene, phloroglucin, trimellitic acid, isatinbis (o-cresol), and the like can be used as a branching agent (polyfunctional aromatic compound).

The PC-POS copolymer has been disclosed in, for example, JP 03-292359 A, JP 04-202465 A, JP 08-81620 A, JP 08-302178 A, or JP 10-7897 A.

A copolymer whose polycarbonate portion has a polymerization degree of about 3 to 100 and whose polyorganosiloxane portion has a polymerization degree of about 2 to 500 is preferably used as the PC-POS copolymer.

In addition, the content of the polyorganosiloxane portion in the PC-POS copolymer is preferably 0.3 to 5 mass %, more preferably 0.5 to 4 mass % from the viewpoint of, for example, a balance between a flame retardancy-imparting effect on a polycarbonate resin composition to be obtained and economical efficiency.

Further, the PC-POS copolymer has a viscosity-average molecular weight (Mv) of typically 5,000 to 100,000, preferably 10,000 to 30,000, more preferably 12,000 to 30,000. Here, such viscosity-average molecular weight (Mv) can be determined in the same manner as in the general polycarbonate resin.

The polyorganosiloxane portion in the PC-POS copolymer is preferably a segment formed of, for example, a polydimethylsiloxane, a polydiethylsiloxane, or a polymethylphenylsiloxane, particularly preferably a polydimethylsiloxane segment.

The aromatic polycarbonate resin as the component (A) can appropriately contain, in addition to the aromatic polycarbonate resin and the PC-POS copolymer, a copolymer resin such as a polyester-polycarbonate resin obtained by performing the polymerization of a polycarbonate in the presence of an ester precursor such as a bifunctional carboxylic acid like terephthalic acid or an ester-formable derivative thereof, or any other polycarbonate resin to such an extent that the object of the present invention is not impaired.

((B) Glass Fibers)

The glass fibers as the component (B) in the present invention are such that a difference between the refractive index of each of the fibers and the refractive index of the aromatic polycarbonate resin as the component (A) is 0.02 or less. In particular, the refractive index of the component (B) and the refractive index of the component (A) are preferably identical to each other. When the difference between the refractive index of the component (B) and the refractive index of the component (A) exceeds 0.02, the galactic or metallic appearance of a molded article obtained by using the polycarbonate resin composition becomes insufficient.

In the present invention, glass fibers each having a refractive index of 1.583 to 1.587 can be used as the component (B).

Glass of which such glass fibers are constituted is, for example, a “glass I” or “glass II” having the following composition.

It is preferred that the “glass I” contain 50 to 60 mass % of silicon oxide (SiO₂), 10 to 15 mass % of aluminum oxide (Al₂O₃), 15 to 25 mass % of calcium oxide (CaO), 2 to 10 mass % of titanium oxide (TiO₂), 2 to 8 mass % of boron oxide (B₂O₃), 0 to 5 mass % of magnesium oxide (MgO), 0 to 5 mass % of zinc oxide (ZnO), 0 to 5 mass % of barium oxide (BaO), 0 to 5 mass % of zirconium oxide (ZrO₂), 0 to 2 mass % of lithium oxide (Li₂O), 0 to 2 mass % of sodium oxide (Na₂O), and 0 to 2 mass % of potassium oxide (K₂O), and have a total content of the lithium oxide (Li₂O), the sodium oxide (Na₂O), and the potassium oxide (K₂O) of 0 to 2 mass %.

On the other hand, it is preferred that the “glass II” contain 50 to 60 mass % of silicon oxide (SiO₂), 10 to 15 mass % of aluminum oxide (Al₂O₃), 15 to 25 mass % of calcium oxide (CaO), 2 to 5 mass % of titanium oxide (TiO₂), 0 to 5 mass % of magnesium oxide (MgO), 0 to 5 mass % of zinc oxide (ZnO), 0 to 5 mass % of barium oxide (BaO), 2 to 5 mass % of zirconium oxide (ZrO₂), 0 to 2 mass % of lithium oxide (Li₂O), 0 to 2 mass % of sodium oxide (Na₂O), and 0 to 2 mass % of potassium oxide (K₂O), be substantially free of boron oxide (B₂O₃), and have a total content of the lithium oxide (Li₂O), the sodium oxide (Na₂O), and the potassium oxide (K₂O) of 0 to 2 mass %.

The content of SiO₂ in each of the “glasses I and II” is preferably 50 to 60 mass % from the viewpoints of the strength of the glass fibers and solubility at the time of the production of each of the glasses. The content of Al₂O₃ is preferably 10 to 15 mass % from the viewpoints of the chemical durability of each of the glasses such as water resistance and solubility at the time of the production of each of the glasses. The content of CaO is preferably 15 to 25 mass % from the viewpoints of solubility at the time of the production of each of the glasses and the suppression of the crystallization of each of the glasses.

The “glass I” can contain 2 to 8 mass % of B₂O₃ like the E glass. In this case, the content of TiO₂ is preferably 2 to 10 mass % from the viewpoints of, for example, an improving effect on the refractive index of the glass and the suppression of the devitrification of the glass.

In addition, it is preferred that the “glass II” be substantially free of B₂O₃ like ECR glass composition, which is excellent in acid resistance and alkali resistance. In this case, the content of TiO₂ is preferably 2 to 5 mass % from the viewpoint of the adjustment of the refractive index of the glass. In addition, the content of ZrO₂ is preferably 2 to 5 mass % from the viewpoints of an increase in refractive index of the glass, an improvement in chemical durability of the glass, and solubility at the time of the production of the glass.

In each of the “glasses I and II”, MgO is an arbitrary component, and can be incorporated at a content of about 0 to 5 mass % from the viewpoints of an improvement in durability of each of the glasses such as a tensile strength and solubility at the time of the production of each of the glasses. In addition, ZnO and BaO are also arbitrary components, and each of them can be incorporated at a content of about 0 to 5 mass % from the viewpoints of an increase in refractive index of each of the glasses and the suppression of the devitrification of each of the glasses.

In the “glass I”, ZrO₂ is an arbitrary component, and can be incorporated at a content of about 0 to 5 mass % from the viewpoints of an increase in refractive index of the glass and solubility at the time of the production of the glass.

In each of the “glasses I and II”, Li₂O, Na₂O, and K₂O as alkali components are arbitrary components, and each of them can be incorporated at a content of about 0 to 2 mass %. In addition, the total content of the alkali components is preferably 0 to 2 mass %. When the total content is 2 mass % or less, a reduction in water resistance of each of the glasses can be suppressed.

As described above, each of the “glasses I and II” contains a small amount of alkali components, and hence a reduction in molecular weight of the polycarbonate resin composition due to the decomposition of the aromatic polycarbonate resin as the component (A) can be suppressed, and reductions in physical properties of an article molded out of the polycarbonate resin composition can be prevented.

Each of the “glasses I and II” may contain, in addition to the glass components, for example, an oxide containing an element such as lanthanum (La), yttrium (Y), gadolinium (Gd), bismuth (Bi), antimony (Sb), tantalum (Ta), niobium (Nb), or tungsten (W) as a component for increasing the refractive index of the glass to such an extent that the spinning property, water resistance, and the like of the glass are not adversely affected. In addition, each of the glasses may contain an oxide containing an element such as cobalt (Co), copper (Cu), or neodymium (Nd) as a component for discoloring the yellow color of the glass.

In addition, the content of Fe₂O₃ as an impurity on an oxide basis in the glass raw materials to be used in the production of each of the “glasses I and II” is preferably less than 0.01 mass % with respect to the entirety of the glass in order that the coloring of the glass may be suppressed.

The glass fibers as the component (B) can be obtained by employing a conventionally known spinning method for glass long fibers. For example, glass can be turned into fibers by employing any one of the various methods such as: a direct melt (DM) method involving continuously turning glass raw materials into glass in a melting furnace, introducing the resultant glass into a forehearth, and attaching a bushing to the bottom of the forehearth to spin the glass; and a remelting method involving processing molten glass into a marble-, cullet-, or rod-like shape, remelting the resultant, and spinning the resultant.

Although the diameter of each of the glass fibers is not particularly limited, fibers each having a diameter of about 3 to 25 μm are preferably used in ordinary cases. When the diameter is 3 μm or more, diffuse reflection is suppressed, whereby a reduction in transparency of the molded article can be prevented. In addition, when the diameter is 25 μm or less, the molded article to be obtained has a good strength.

In the present invention, the average length of the glass fibers in a polycarbonate resin composition pellet or the molded article is 300 μm or more, preferably 350 μm or more. When the average length of the glass fibers is less than 300 μm, a tendency becomes apparent, that an effect of decreasing the difference in luminosity between the left and right sides of the weld line becomes difficult to be obtained. It should be noted that the average length can be measured by incinerating a part of the resin composition pellet or the molded article by an electric furnace in air at 600° C. for 2 hours, and then observing combustion residues by a microscope and the like.

In addition, the surface of the glass fibers as the component (B) is preferably treated with a coupling agent in order that the glass fibers may show an increased affinity for the aromatic polycarbonate resin as the component (A), adhesiveness between the glass fibers and the resin may be improved, and reductions in transparency and strength of the molded article due to the formation of voids in the glass fibers may be suppressed. A silane-based coupling agent, a borane-based coupling agent, an aluminate-based coupling agent, a titanate-based coupling agent, or the like can be used as the coupling agent. The silane-based coupling agent is particularly preferably used because adhesiveness between the aromatic polycarbonate resin and the glass fibers can be improved.

Specific examples of the silane-based coupling agent include triethoxysilane, vinyltris(β-methoxyethoxy)silane, γ-methacryloxypropyltrimethoxysilane, γ-glycidoxypropyltrimethoxysilane, β-(1,1-epoxycyclohexyl)ethyltrimethoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyl dimethoxysilane, γ-aminopropyltriethoxysilane, N-phenyl-γ-aminopropyltrimethoxysilane, γ-mercaptopropyltrimethoxysilane, γ-chloropropyltrimethoxysilane, γ-aminopropyltrimethoxysilane, γ-aminopropyltris(2-methoxy-ethoxy)silane, N-methyl-γ-aminopropyltrimethoxysilane, N-vinylbenzyl-γ-aminopropyltriethoxysilane, triaminopropyltrimethoxysilane, 3-ureidopropyltrimethoxysilane, 3-(4,5-dihydroimidazolyl)propyltriethoxysilane, hexamethyldisilazane, N,O-(bistrimethylsilyl)amide, and N,N-bis(trimethylsilyl) urea. Of those, preferred are amino silanes and epoxysilanes such as γ-aminopropyltrimethoxysilane, N-β-(aminoethyl)-γ-aminopropyltrimethoxysilane, γ-glycidoxypropyltrimethoxysilane, and β-(3,4-epoxycyclohexyl)ethyltrimethoxysilane.

The surface of the glass fibers can be treated with such coupling agent by an ordinary known method without any particular limitation. The surface treatment can be performed by an appropriate method, and examples of the method include a sizing treatment method involving applying a solution or suspension of the coupling agent in an organic solvent as the so-called sizing agent to the glass fibers, a dry mixing method involving the use of a Henschel mixer, a super mixer, a Redige mixer, a V-type blender, or the like, a spray method, an integral blend method, and a dry concentrate method. The surface treatment is desirably performed by the sizing treatment method, the dry mixing method, or the spray method.

The content of the component (B) in the glass fiber-containing resin component formed of the component (A), the component (B), and the component (C) is 5 to 20 mass %, preferably 5 to 15 mass %. When the content is less than 5 mass %, improving effects on the mechanical properties such as rigidity cannot be obtained. When the content exceeds 20 mass %, the specific gravity increases, and the impact resistance and the flowability reduce.

((C) Polymethyl Methacrylate Resin)

The polycarbonate resin composition of the present invention can promote a metallic feeling-expressing effect because the composition contains the polymethyl methacrylate resin as the component (C). Accordingly, the content of (D) the glossy particles can be reduced and the occurrence of a weld line in a resin molded article can be reduced. In addition, a difference in luminosity between the left and right sides with respect to the weld line can be reduced.

The polymethyl methacrylate resin that can be used as the component (C) may be a homopolymer of methyl methacrylate, or may be a copolymer obtained by copolymerizing methyl methacrylate as a main component and one or two or more kinds of other vinyl monomers such as an acrylate, any other methacrylate, styrene, and acrylonitrile as long as the object of the present invention is not impaired.

The content of the component (C) in the glass fiber-containing resin component formed of the component (A), the component (B), and the component (C) is 5 to 25 mass %, preferably 5 to 15 mass %. When the content is less than 5 mass %, the content of the glossy particles as the component (D) increases, thereby making it difficult to reduce the difference in luminosity between the left and right sides with respect to a weld line. When the content exceeds 25 mass %, the characteristics of the aromatic polycarbonate resin as the component (A), in particular, its impact resistance and heat resistance are impaired. In addition, when the content exceeds 25 mass %, a defect may occur in the appearance of a molded article owing to, for example, the heat decomposition of the component (C) because the component (A) and the component (C) have different proper molding temperature in a molding process.

((D) Glossy Particles)

Examples of the glossy particles as the component (D) in the present invention include mica, metal particles, metal sulfide particles, particles each having a surface coated with a metal or a metal oxide, and glass flakes each having a surface coated with a metal or a metal oxide. Those may be used alone, or two or more kinds thereof may be used in combination.

Specific examples of the metal particles include metal powders each made of, for example, aluminum, gold, silver, copper, nickel, titanium, or stainless steel. Specific examples of the particles each having a surface coated with a metal or a metal oxide include metal oxide coated mica-based particles such as mica titanium coated with titanium oxide and mica coated with bismuth trichloride. Specific examples of the metal sulfide particles include metal sulfide powders each made of, for example, nickel sulfide, cobalt sulfide, or manganese sulfide. A metal used in each of the glass flakes each having a surface coated with a metal or a metal oxide is, for example, gold, silver, platinum, palladium, nickel, copper, chromium, tin, titanium, or silicon.

Here, glossy particles having a small average particle diameter generally have such properties that the particles each have an inconspicuous orientation but each provide poor metallic feeling. In contrast, glossy particles having a large average particle diameter have such properties that the particles each provide excellent metallic feeling but each have a conspicuous orientation. In addition, quality drawbacks such as the occurrence of the weld line of the resin molded article, and the difference in luminosity between the left and right sides with respect thereto arise depending on the sizes and content of the glossy particles. Accordingly, it is important to select the sizes of the glossy particles to be used and specify the contents of these particles. That is, when as described below, two kinds of different average particle diameter ranges of the component (D-1) and the component (D-2) are specified for the glossy particles, and these two kinds of glossy particles are used in combination so that their contents may take specific values, a metallic feeling is imparted and the orientations of the glossy particles themselves are reduced. In addition, the occurrence of a weld line, and the difference in luminosity between the left and right sides with respect thereto can be reduced.

The average particle diameter of the glossy particles as the component (D-1) is 10 μm or more and less than 60 μm, and the average particle diameter of the glossy particles as the component (D-2) is 60 μm to 300 μm.

The average particle diameter of the glossy particles can be determined from the result of a particle size distribution measured for a kerosene-based solution containing the glossy particles at a concentration of 0.1 mass % with, for example, a laser diffraction particle size distribution-measuring apparatus (MASTER SIZER 2000 manufactured by Malvern Instruments Ltd.).

The content of the component (D-1) is 0.005 to 1.5 part by mass, preferably 0.01 to 0.1 part by mass with respect to 100 parts by mass of the glass fiber-containing resin component formed of the component (A), the component (B), and the component (C). The content of the component (D-2) is 0.005 to 5 parts by mass, preferably 0.05 to 2 parts by mass with respect to 100 parts by mass of the glass fiber-containing resin component. When the contents of the component (D-1) or the component (D-2) are less than 0.005 part by mass, a galactic appearance or a metallic appearance is not formed, and hence the occurrence of a weld line, and the difference in luminosity between the left and right sides with respect thereto cannot be reduced. In addition, when the content of the component (D-1) exceeds 1.5 parts by mass or the content of the component (D-2) exceeds 5 parts by mass, the amount in which the glossy particles themselves float on the surface of a molded product increases to impair its appearance. In addition, a weld line is formed, and the difference in luminosity between the left and right sides with respect thereto is apt to occur.

In addition, a mass ratio between the component (D-1) and the component (D-2) in the polycarbonate resin composition preferably falls within the range of 1:1 to 1:7 from the viewpoint of the difference in luminosity between the left and right sides with respect to the weld line.

((E) Titanium Oxide)

In the present invention, titanium oxide as the component (E) has an average particle diameter of 0.05 to 3 μm. When the average particle diameter is less than 0.05 μm, a weld line becomes easily visible and hence a visibility-reducing effect cannot be obtained. When the average particle diameter exceeds 3 μm, the component is poor in dispersibility in the resin composition. The average particle diameter is preferably 0.1 to 0.5 μm.

The component (E) to be used in the present invention is typically used in the form of a fine powder. Although the component may be of any one of a rutile type and an anatase type, the component is preferably of a rutile type in terms of, for example, heat stability and weatherability. In addition, the shapes of the fine powder particles are not particularly limited, and a flaky shape, a spherical shape, an amorphous shape, or the like can be appropriately selected and used.

In addition, titanium oxide to be used as the component (E) may be subjected to a surface treatment with an amine compound, a polyol compound, or the like as well as a water-containing oxide of aluminum and/or silicon. Performing the treatment improves its uniform dispersibility in the polycarbonate resin composition and the stability of the dispersed state, thereby enabling the production of a uniform composition. An alumina hydrated compound, a silica hydrated compound, triethanolamine, and trimethylolethane can be given as examples of the water-containing oxides of aluminum and silica, the amine compound, and the polyol compound, respectively. A treatment method itself in the surface treatment is not particularly limited and an arbitrary method is appropriately adopted. Although the amount of a surface treatment agent to be provided for the surfaces of the titanium oxide particles by the treatment is not particularly limited, a proper amount is typically about 0.1 to 10.0 mass % with respect to titanium oxide in consideration of the moldability of the resin composition.

The content of the component (E) is 0.05 to 0.4 part by mass, preferably 0.05 to 0.3 part by mass with respect to 100 parts by mass of the glass fiber-containing resin component formed of the component (A), the component (B), and the component (C). When the content is less than 0.05 part by mass, a weld line becomes easily visible and hence its visibility cannot be reduced. On the other hand, when the content exceeds 0.4 part by mass, a metallic feeling is impaired. The visibility of the weld line can be alleviated by incorporating a large amount of large titanium oxide particles. On the other hand, however, the metallic feeling of a molded article is impaired. Accordingly, the content of the glossy particles needs to be increased. As a result, however, the difference in luminosity between the left and right sides with respect to the weld line enlarges.

((F) Colorant)

In the present invention, a colorant as a component (F) can be incorporated when a colored molded article is desired.

The colorant as the component (F) to be used varies depending on a desired color. For example, in order that a silver metallic base color may be expressed, aluminum powder particles are preferably used. When the aluminum powder particles are used for expressing the silver metallic tone, particles each having a proper size need to be selected because the particles serve in the same manner as in the glossy particles. An excessively large size is apt to be responsible for the occurrence of a gel. Accordingly, the average particle diameter of the aluminum powder particles is preferably about 30 to 80 μm.

The content of the component (F), which has only to be appropriately adjusted depending on the hue of the molded article, is preferably 0.0001 to 1 part by mass, more preferably 0.1 to 0.3 part by mass with respect to 100 parts by mass of the glass fiber-containing resin component formed of the component (A), the component (B), and the component (C) in ordinary cases. For example, when the aluminum powder particles are used, as long as the content is 0.0001 part by mass or more, the case where the content is so small that the molded article looks white can be avoided. As long as the content is 1 part by mass or less, the case where the content is so large that the molded article looks dark gray can be avoided. As long as the content falls within the range, a desired silver metallic tone can be obtained in ordinary cases.

Further, examples of the colorant which may be used as the component (F) other than the aluminum powder particles include a methine-based dye, a pyrazolone-based dye, a perinone-based dye, an azo-based dye, a quinophthalone-based dye, and an anthraquinone-based dye. Of those, from the viewpoint of, for example, heat resistance and durability of the composition, anthraquinone-based orange dyes and green dyes can be preferably used alone or in a mixture of them.

(Any Other Arbitrary Component)

A general-purpose polystyrene-based resin (GPPS) as well as the components (A) to (F) can be incorporated into the polycarbonate resin composition of the present invention. As the GPPS exerts a promoting effect on the expression of a metallic feeling as with (C) the polymethyl methacrylate resin, a required amount of the GPPS can be appropriately incorporated to such an extent that the object of the present invention is not impaired.

In addition, additives such as a release agent, a stabilizer (antioxidant), a UV absorber, an antistatic agent, and a fluorescent bleach can be appropriately incorporated as required to such an extent that the object of the present invention is not impaired.

A higher fatty acid ester of a monohydric or polyhydric alcohol may be exemplified as the release agent which may be added where required. Such higher fatty acid ester is preferably a partial or complete ester of a monohydric or polyhydric alcohol having 1 to 20 carbon atoms and a saturated fatty acid having 10 to 30 carbon atoms. Examples of the partial or complete ester of a monohydric or polyhydric alcohol and a saturated fatty acid include monoglyceride stearate, monosorbitate stearate, monoglyceride behenate, pentaerythritol monostearate, pentaerythritol tetrastearate, propyleneglycol monostearate, stearyl stearate, palmityl palmitate, butyl stearate, methyl laurate, isopropyl palmitate, and 2-ethylhexyl stearate. Of those, monoglyceride stearate and pentaerythritol tetrastearate are preferably used.

One kind of those release agents may be used alone, or two or more kinds of them may be used in combination. Such release agent is typically added in an amount of about 0.1 to 5.0 parts by mass with respect to 100 parts by mass of the glass fiber-containing resin component formed of the component (A), the component (B), and the component (C).

As a stabilizer (antioxidant) which may be added where required, phenol-based antioxidants and phosphorous-based antioxidants are exemplified.

Examples of the phenol-based antioxidants include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamide), 3,5-di-tert-butyl-4-hydroxy-benzylphophonate diethyl ester, tris(3,5-di-tert-butyl-4-hydroxybenzyl)isocyanurate, and 3,9-bis[1,1-dimethyl-2-[β-(3-tert-butyl-4-hydroxy-5-methylphenyl)propionyloxy]ethyl]-2,4,8,10-tetraoxaspiro(5,5)undecane.

Examples of the phosphorous-based antioxidants include triphenyl phosphite, trisnonylphenyl phosphite, tris(2,4-di-tert-butylphenyl) phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, bis(2,6-di-tert-butyl-4-methylphenyl)pentaerythritol diphosphite, 2,2-methylenebis(4,6-di-tert-butylphenyl)octyl phosphite, bis(nonylphenyl)pentaerythritol diphosphite, bis(2,4-di-tert-butylphenyl)pentaerythritol diphosphite, and distearyl pentaerythritol diphosphite.

One kind of those antioxidants may be used alone, or two or more kinds of them may be used in combination. Such antioxidant is typically added in an amount of about 0.05 to 1.0 part by mass with respect to 100 parts by mass of the glass fiber-containing resin component formed of the component (A), the component (B), and the component (C).

As the UV absorber, a benzotriazole-based UV absorber, a triazine-based UV absorber, a benzoxazine-based UV absorber, a benzophenone-based UV absorber, or the like may be used.

Examples of the benzotriazole-based UV absorber include 2-(2′-hydroxy-5′-methylphenyl)benzotriazole, 2-(2′-hydroxy-3′-(3,4,5,6-tetrahydrophthalimidomethyl)-5′-methylphenyl)benzotriazole, 2-(2′-hydroxy-3′,5′-di-tert-butylphenyl)benzotriazole, 2-(2′-hydroxy-5′-tert-octylphenyl)benzotriazole, 2-(3′-tert-butyl-5′-methyl-2′-hydroxyphenyl)-5-chlorobenzotriazole, 2,2′-methylenebis(4-(1,1,3,3-tetramethylbutyl)-6-(2H-benzotriazol-2-yl)phenol), 2-(2′-hydroxy-3′5′-bis(α,α-dimethylbenzyl)phenyl)-2H-benzotriazole, 2-(3′,5′-di-tert-amyl-2′-hydroxyphenyl)benzotriazole, and 5-trifluoromethyl-2-(2-hydroxy-3-(4-methoxy-α-cumyl)-5-tert-butylphenyl)-2H-benzotriazole. Of those, 2-(2′-hydroxy-5′-tert-octylphenyl)benzotriazole is preferred.

As the triazine-based UV absorber, for example, TINUVIN 400 (trade name) (manufactured by Ciba Specialty Chemicals Inc.) which is a hydroxyphenyltriazine-based UV absorber is preferred.

Examples of the benzoxazine-based UV absorber include 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2,2′-bis(3,1-benzoxazin-4-one), 2,2′-p-phenylenebis(3,1-benzoxazin-4-one), 2,2′-m-phenylenebis(3,1-benzoxazin-4-one), 2,2′-(4,4′-diphenylene)bis(3,1-benzoxazin-4-one), 2,2′-(2,6- or 1,5-naphthalene)bis(3,1-benzoxazin-4-one), and 1,3,5-tris(3,1-benzoxazin-4-one-2-yl)benzene. Of those, 2,2′-p-phenylenebis(3,1-benzoxazin-4-one) is preferred.

Examples of the benzophenone-based UV absorber include 2-hydroxy-4-methoxybenzophenone, 2-hydroxy-4-n-octoxybenzophenone, 2-hydroxy-4-methoxy-2′-carboxybenzophenone, 2,4-dihydroxybenzophenone, and 2,2′-dihydroxy-4-methoxybenzophenone. Of those, 2-hydroxy-4-n-octoxybenzophenone is preferred.

One kind of those UV absorbers may be used alone, or two or more kinds of them may be used in combination. Such UV absorber is typically added in an amount of about 0.05 to 2.0 parts by mass with respect to 100 parts by mass of the glass fiber-containing resin component formed of the component (A), the component (B), and the component (C).

As the antistatic agent, for example, a monoglyceride of the fatty acid having 14 to 30 carbon atoms, and more specifically, monoglyceride stearate, monoglyceride palmitate, or a polyamide polyether block copolymer may be used.

As the fluorescent bleach, for example, stilbene-based, benzoimidazole-based, naphthalimide-based, rhodamine-based, coumarin-based, and oxazine-based compounds are exemplified. More specifically, commercially-available products such as UVITEX (trade name, manufactured by Ciba Specialty Chemicals Inc.), OB-1 (trade name, manufactured by Eastman Chemical Company), TBO (trade name, manufactured by SUMITOMO SEIKA CHEMICALS CO., LTD.), Kaycoll (trade name, manufactured by NIPPON SODA CO., LTD.), Kayalight (trade name, manufactured by NIPPON KAYAKU CO., LTD.), and Leucophor EGM (trade name, manufactured by Clariant Japan) may be used.

(Preparation Method)

A method of preparing the polycarbonate resin composition of the present invention is not particularly limited, and a conventionally known method can be adopted. To be specific, the composition can be prepared by: blending the components (A) to (F), and, as required, other arbitrary components each at a predetermined ratio; and kneading the mixture.

The blending and the kneading are performed by preliminarily mixing the compounds using commonly used devices such as a ribbon blender and a drum tumbler, and using a Henschel mixer, a Banbury mixer, a single-screw extruder, a twin-screw extruder, a multi-screw extruder, and a cokneader. Heating temperature in kneading is appropriately selected generally from a range of about 240 to 300° C.

It should be noted that any component to be incorporated other than the aromatic polycarbonate resin can be melted and kneaded with part of the aromatic polycarbonate resin in advance before being added: the component can be added as a master batch.

Thus, the polycarbonate resin composition of the present invention is prepared.

(Polycarbonate Resin Molded Article and Manufacturing Method Therefor)

Next, a polycarbonate resin molded article of the present invention is described.

The polycarbonate resin molded article of the present invention is obtained by molding the above-mentioned polycarbonate resin composition of the present invention using an injection molding method or the like. Upon molding, the thickness of the polycarbonate molded article is preferably about 0.3 to 10 mm, and is appropriately selected from the range depending on an application of the molded article.

A method of producing the polycarbonate resin molded article of the present invention is not particularly limited, and any one of the various conventionally known molding methods such as an injection molding method, an injection compression molding method, an extrusion molding method, a blow molding method, a press molding method, a vacuum molding method, and a foam molding method can be employed; injection molding at a mold temperature of 120° C. or more, preferably 120° C. to 140° C. is preferred. In this case, a resin temperature in the injection molding is typically about 240 to 300° C., preferably 260 to 280° C.

Injection molding at a mold temperature of 120° C. or more, preferably 120° C. to 140° C. provides, for example, such merit that the glass fibers sink, and the molded article can provide a good appearance. The mold temperature is more preferably 125° C. or more and 140° C. or less, still more preferably 130° C. to 140° C. The PC resin composition of the present invention as a molding raw material is preferably pelletized by the melt-kneading method before being used. It should be noted that gas injection molding for the prevention of sink marks in the appearance of the molded article or for a reduction in weight of the molded article can be adopted as an injection molding method.

In the thus obtained polycarbonate resin molded article of the present invention, the occurrence of a weld line is reduced, and even when a weld line is formed, the difference in luminosity between the left and right sides of the weld line is not visually observed, and a good metallic appearance or a galactic appearance can be obtained on the entire surface of the molded article.

It should be noted that the difference in luminosity between the left and right sides of the weld line can be measured by a method involving: irradiating a test piece with daylight from an oblique angle of 45°; and visually observing the left and right sides of the weld line.

In addition, the present invention provides a method of producing a polycarbonate resin molded article characterized by including subjecting the above-mentioned polycarbonate resin composition of the present invention to injection molding at a mold temperature of 120° C. or more, preferably 120° C. to 140° C. to produce a molded article.

The polycarbonate resin molded article of the present invention is preferably used for the following items, for example:

(1) various parts of televisions, radio cassettes, video cameras, videotape recorders, audio players, DVD players, air conditioners, cellular phones, displays, computers, resistors, electric calculators, copiers, printers, and facsimiles, and electrical/electronic device parts such as outside plates and housing materials;
(2) parts for precision machinery such as cases and covers for precision machines such as PDA's, cameras, slide projectors, clocks, gauges, display instruments;
(3) parts for automobiles such as automobile interior materials, exterior products, and automobile body parts including instrument panels, upper garnishes, radiator grills, speaker grills, wheel covers, sunroofs, head lamp reflectors, door visors, spoilers, rear windows, and side windows; and
(4) parts for furniture such as chairs, tables, desks, blinds, lighting covers, and interior instruments.

### EXAMPLES

Hereinafter the present invention is described in more detail by way of examples and comparative examples, but the present invention is not limited thereto.

It should be noted that a test piece was molded out of a polycarbonate resin composition pellet obtained in each of the following examples and comparative examples as described below, and was evaluated for various characteristics.

[Evaluation Test]

### (1) Mechanical Properties

A pellet was subjected to injection molding with a 100-t injection molding machine (manufactured by TOSHIBA MACHINE CO., LTD., device name “IS100E”) at a mold temperature of 130° C. and a resin temperature of 280° C., whereby respective test pieces each having a predetermined form were produced. The tensile properties (breaking strength and elongation) of each test piece were measured in conformity with ASTM D638, and the flexural properties (strength and elastic modulus) of the test piece were measured in conformity with ASTM 790.

In addition, the Izod impact strength of the test piece was measured in conformity with ASTM D256.

(2) Physical Properties (Deflection Temperature under Load and Specific Gravity)

A polycarbonate resin composition pellet was subjected to injection molding with a 100-t injection molding machine (manufactured by TOSHIBA MACHINE CO., LTD., device name “IS100E”) at a mold temperature of 130° C. and a resin temperature of 280° C., whereby respective test pieces each having a predetermined form were produced.

The deflection temperature under load of each test piece was measured in conformity with ASTM D648, and the obtained temperature was used as the index of heat resistance. The specific gravity of the test piece was measured in conformity with ASTM D792.

### (3) Difference in Luminosity Between Left and Right Sides of Weld Line

A polycarbonate resin composition pellet was subjected to injection molding with a mold having two-point-gate by using a 100-t injection molding machine (manufactured by Sumitomo Heavy Industries, Ltd., device name “SG100M-HP”) at a mold temperature of 130° C., whereby a test piece having a weld line and measuring 80×80×2 mm was produced. The thus obtained test piece was irradiated with daylight in an oblique direction of 45° and was determined whether the difference in luminosity of the glossy particles between the left and right sides of the weld line could be visually observed, and was then evaluated by the following five-stage criteria.

5 : No difference is visible, 4: nearly no difference is visible, 3: the difference is somewhat conspicuous, 2: the difference is conspicuous, 1: the difference is clearly visible.

### (4) Weld Line

A polycarbonate resin composition pellet was subjected to injection molding with a 100-t injection molding machine (manufactured by TOSHIBA MACHINE CO., LTD., device name “IS100E”) at a mold temperature of 130° C. and a resin temperature of 280° C., whereby respective test pieces each having a predetermined form were produced. The surface appearance of the test piece was visually observed and evaluated for its weld black line by the following five-stage criteria.

5: No weld black line is visible, 4: nearly no weld black line is visible, 3: a weld black line is somewhat conspicuous, 2: a weld black line is conspicuous, 1: a weld black line is clearly visible.

### (5) Metallic Feeling

The surface appearance of a test piece produced in the same manner as the test piece for the weld line evaluation test was visually observed, and was then evaluated for whether the appearance had a metallic feeling targeted by the present invention by the following five-stage criteria.

5: A metallic feeling is sufficient, 4: the appearance has a good metallic feeling, 3: the appearance has a metallic feeling, 2: the appearance has nearly no metallic feeling, 1: the appearance has no metallic feeling.

[Resin Composition Component]

The respective components used in the production of each polycarbonate resin composition pellet are shown below.

### (Component (A))

Aromatic PC resin: Bisphenol A polycarbonate having a viscosity-average molecular weight of 17,000 (manufactured by Idemitsu Kosan Co., Ltd., trade name “TARFLON FN1700A”, and a refractive index of 1.585)
PC-PDMS: polycarbonate-polydimethylsiloxane copolymer (viscosity average molecular weight: 18,500, content of PDMS part: 4.8 mass %, chain length (n) of PDMS part: 90, refractive index: 1.574 to 1.576)

### (Component (B))

Glass fibers: glass fibers (manufactured by ASAHI FIBER GLASS Co., Ltd., trade name “KK03NAFT737-S1”, a refractive index of 1.585)

### (Component (C))

PMMA: polymethylmethacrylate (manufactured by Sumitomo Chemical Co., Ltd., trade name “SMIPEX MGSS”)

### (Component (D))

(D-1) Glossy particles 1: glass flakes having an average particle diameter of 40 μm coated with titania (manufactured by NIPPON SHEET GLASS Co., Ltd., trade name “MC104ORS”)
(D-2) Glossy particles 2: glass flakes having an average particle diameter of 90 μm coated with silver (manufactured by NIPPON SHEET GLASS Co., Ltd., trade name “MC5090RS”)
(D-1) Glossy particles 3: glass flakes having an average particle diameter of 50 μm (manufactured by MERCK Ltd., Japan, trade name “Xirallic T5010”)
(D-2) Glossy particles 4: glass flakes having an average particle diameter of 100 μm (manufactured by MERCK Ltd., Japan, trade name “Miraval 5311”)

### (Component (E))

Titanium oxide: rutile type titanium oxide having an average particle diameter of 0.2 μm (manufactured by Ishihara Sangyo Kaisha Ltd., trade name “CR60-2”)

### (Component (F))

Colorant (aluminum powder particles): particles having an average particle diameter of 35 μm (manufactured by Nihonboshitsu Co., Ltd., trade name “NJ80”)

### Examples 1 to 11 and Comparative Examples 1 to 11

In each of the examples and the comparative examples, the respective components were mixed at a blending ratio shown in Tables 1 and 2, and the mixture was melted and kneaded with a twin-screw extruder (manufactured by TOSHIBA MACHINE CO., LTD., device name “TEM-35B”) at 280° C., whereby a polycarbonate resin composition pellet was produced. The above-mentioned evaluation test was performed using each pellet. Tables 1 and 2 show the results all together.

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Compo- | (A) | Aromatic PC resin (%) | 80 | 80 | 80 | 80 | 80 | 80 | 80 | 60 | 80 | 20 | 10 |
| sition | | PC-PDMS (%) | — | — | — | — | — | — | — | — | — | 50 | 70 |
| | (B) | Glass fibers (%) | 10 | 10 | 10 | 10 | 10 | 10 | 10 | 20 | 10 | 10 | 10 |
| | (C) | PMMA (%) | 10 | 10 | 10 | 10 | 10 | 10 | 10 | 10 | 10 | 20 | 10 |
| | (D) | (D-1) Glossy particles 1 Average particle | 1 | 1 | 1 | 1 | 0.5 | 0.5 | 0.5 | 1 | 1 | 1 | 0.5 |
| | | diameter 40 μm (part(s)) | | | | | | | | | | | |
| | | (D-2) Glossy particles 2 Average particle | 2 | 2 | 2 | 2 | 2 | 2 | 2 | 2 | 2 | 2 | 3 |
| | | diameter 90 μm (part(s)) | | | | | | | | | | | |
| | | (D-1) Glossy particles 3 Average particle | — | — | — | — | — | — | — | — | — | — | — |
| | | diameter 50 μm (part (s)) | | | | | | | | | | | |
| | | (D-2) Glossy particles 4 Average particle | — | — | — | — | — | — | — | — | — | — | — |
| | | diameter 100 μm (part(s)) | | | | | | | | | | | |
| | (E) | Titanium oxide (part(s)) | 0.14 | 0.14 | 0.14 | 0.14 | 0.14 | 0.14 | 0.14 | 0.14 | 0.3 | 0.14 | 0.15 |
| | (F) | Colorant (aluminum powder particles) | 0.15 | 0.1 | 0.2 | — | 0.15 | 0.15 | 0.15 | 0.1 | 0.1 | 0.15 | 0.2 |
| | | (part(s)) | | | | | | | | | | | |
| Evalu- | (1) | Tensile break strength (Mpa) | 80 | 80 | 80 | 80 | 80 | 80 | 80 | 100 | 80 | 77 | 80 |
| ation | | Tensile elongation (%) | 4 | 4 | 4 | 4 | 4 | 4 | 4 | 4 | 4 | 6 | 10 |
| | | Bending strength (Mpa) | 125 | 125 | 125 | 125 | 125 | 125 | 125 | 140 | 125 | 123 | 122 |
| | | Bending modulus (Mpa) | 4200 | 4200 | 4200 | 4200 | 4200 | 4200 | 4200 | 5900 | 4200 | 4100 | 4100 |
| | | Notched Izod impact strength (kJ/m²) | 8 | 8 | 8 | 8 | 8 | 8 | 8 | 15 | 8 | 25 | 30 |
| | (2) | Deflection temperature under load (° C.) | 138 | 138 | 138 | 138 | 138 | 138 | 138 | 143 | 138 | 135 | 137 |
| | | Specific gravity | 1.3 | 1.3 | 1.3 | 1.3 | 1.3 | 1.3 | 1.3 | 1.33 | 1.3 | 1.32 | 1.3 |
| | (3) | Difference in luminosity between left and | 4 | 4 | 5 | 5 | 4 | 4 | 4 | 4 | 5 | 4 | 5 |
| | | right sides of weld line | | | | | | | | | | | |
| | (4) | Weld line | 4 | 5 | 4 | 5 | 4 | 4 | 5 | 4 | 4 | 4 | 5 |
| | (5) | Metallic feeling | 5 | 5 | 5 | 5 | 5 | 5 | 5 | 5 | 4 | 5 | 5 |

In the column “Composition,” the term “%” means “mass %” in the total amount of the components (A) to (C), and the term “part(s)” means “part (s) by mass” with respect to 100 parts by mass of the total of the components (A) to (C).

TABLE 2

| | | | Comparative Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Compo- | (A) | Aromatic PC resin (%) | 80 | 80 | 80 | 70 | 70 | 70 | 70 | 80 | 80 | 90 | 60 |
| sition | | PC-PDMS (%) | — | — | — | — | — | — | — | — | — | — | — |
| | (B) | Glass fibers (%) | 10 | 10 | 10 | 10 | 10 | 10 | 10 | 10 | 10 | 10 | 10 |
| | (C) | PMMA (%) | 10 | 10 | 10 | 20 | 20 | 20 | 20 | 10 | 10 | — | 30 |
| | (D) | (D-1) Glossy particles 1 Average particle | — | 1 | 1 | — | 0.5 | 0.5 | — | — | 2 | 1 | 1 |
| | | diameter 40 μm (part (s)) | | | | | | | | | | | |
| | | (D-2) Glossy particles 2 Average particle | 1 | — | — | 1 | 1 | 1 | 1 | 2 | 1 | 2 | 2 |
| | | diameter 90 μm (part(s)) | | | | | | | | | | | |
| | | (D-1) Glossy particles 3 Average particle | 0.5 | 1 | 1 | 1 | 0.5 | 0.5 | — | — | — | — | — |
| | | diameter 50 μm (part(s)) | | | | | | | | | | | |
| | | (D-2) Glossy particles 4 Average particle | — | — | — | — | — | — | 2 | 2 | — | — | — |
| | | diameter 100 μm (part(s)) | | | | | | | | | | | |
| | (E) | Titanium oxide (part(s)) | — | 0.1 | 0.1 | — | — | — | 0.12 | 0.1 | 0.12 | 0.14 | 0.14 |
| | (F) | Colorant (aluminum powder particles) | 0.15 | 0.1 | 0.15 | 0.15 | 0.1 | 0.1 | 0.15 | 0.15 | 0.15 | 0.15 | 0.1 |
| | | (part(s)) | | | | | | | | | | | |
| Evalu- | (1) | Tensile break strength (Mpa) | 80 | 80 | 80 | 80 | 80 | 80 | 80 | 80 | 80 | 80 | 80 |
| ation | | Tensile elongation (%) | 4 | 4 | 4 | 3 | 3 | 3 | 3 | 4 | 4 | 5 | 3 |
| | | Bending strength (Mpa) | 125 | 125 | 125 | 127 | 127 | 127 | 127 | 125 | 125 | 120 | 128 |
| | | Bending modulus (Mpa) | 4200 | 4200 | 4200 | 4400 | 4400 | 4400 | 4400 | 4200 | 4200 | 3900 | 4500 |
| | | Notched Izod impact strength (kJ/m²) | 8 | 8 | 8 | 7 | 7 | 7 | 7 | 8 | 8 | 10 | 6 |
| | (2) | Deflection temperature under load (° C.) | 138 | 138 | 138 | 135 | 135 | 135 | 135 | 138 | 138 | 141 | 130 |
| | | Specific gravity | 1.3 | 1.3 | 1.3 | 1.32 | 1.32 | 1.32 | 1.32 | 1.3 | 1.3 | 1.27 | 1.34 |
| | (3) | Difference in luminosity between left and | 4 | 2 | 3 | 3 | 2 | 2 | 2 | 3 | 5 | 3 | 3 |
| | | right sides of weld line | | | | | | | | | | | |
| | (4) | Weld line | 3 | 4 | 4 | 3 | 1 | 3 | 3 | 3 | 3 | 4 | 3 |
| | (5) | Metallic feeling | 5 | 3 | 3 | 4 | 3 | 4 | 4 | 5 | 5 | 5 | 5 |

In the column “Composition,” the term “%” means “mass %” in the total amount of the components (A) to (C), and the term “part(s)” means “part (s) by mass” with respect to 100 parts by mass of the total of the components (A) to (C).

### INDUSTRIAL APPLICABILITY

The polycarbonate resin composition of the present invention has excellent heat resistance and an excellent mechanical strength. While a resin molded article using the resin composition maintains the properties, the occurrence of a weld line is reduced in the molded article. Even when the weld line is formed, no difference in luminosity between the left and right sides thereof is visible, and hence a good metallic or galactic appearance is obtained on the entire surface of the molded article. Accordingly, the composition suitably finds use in applications in a structural member field where a design appearance is requested such as a television, a refrigerator, or a cleaner.

1. A polycarbonate resin composition, comprising:
(A) 100 parts by mass of a glass fiber-comprising resin component comprising
(a1) 60 to 90 mass % of an aromatic polycarbonate resin,
(a2) 5 to 20 mass % of glass fibers, wherein a difference between the refractive index of the aromatic polycarbonate resin (a1) and each of the fibers is 0.02 or less, and
(a3) 5 to 25 mass % of a polymethyl methacrylate resin;
(B) 0.005 to 1.5 parts by mass of (b1) glossy particles having an average particle diameter of 10 μm or more and less than 60 μm, and 0.005 to 5 parts by mass of (b2) glossy particles having an average particle diameter of 60 to 300 μm; and
(C) 0.05 to 0.4 part by mass of titanium oxide having an average particle diameter of 0.05 to 3 μm.

2. The polycarbonate resin composition of claim 1, wherein aromatic polycarbonate resin (a1) comprises 10 to 80 mass % of a polycarbonate-polyorganosiloxane copolymer.

3. The polycarbonate resin composition of claim 2, wherein a content of a polyorganosiloxane portion in the polycarbonate-polyorganosiloxane copolymer is 0.3 to 5 mass %.

4. The polycarbonate resin composition of claim 1, wherein the glass fibers (a2) each have a refractive index of 1.583 to 1.587.

5. The polycarbonate resin composition of claim 1, wherein the glossy particles (B) comprise at least one selected from the group consisting of mica, a metal particle, a metal sulfide particle, a particle having a surface coated with a metal or a metal oxide, and a glass flake having a surface coated with a metal or a metal oxide.

6. The polycarbonate resin composition of claim 1, wherein a mass ratio between the glossy particles (b1) and the glossy particles (b2) in the component B is 1:1 to 1:7.

7. The polycarbonate resin composition of claim 1, further comprising:
(D) 0.0001 to 1 part by mass of a colorant based on 100 parts by mass of the glass fiber-comprising resin component (A).

8. The polycarbonate resin composition of claim 7, wherein the colorant (D) comprises aluminum powder particles.

9. The polycarbonate resin composition of claim 8, wherein the aluminum powder particles have an average particle diameter of 30 to 80 μm.

10. A polycarbonate resin molded article obtained by molding the polycarbonate resin composition of claim 1.

11. The molded article of claim 10, obtained by injection molding the polycarbonate resin composition at a mold temperature of 120° C. or more.

12. A method of producing a polycarbonate resin molded article, the method comprising:
injection molding the polycarbonate resin composition of claim 1 at a mold temperature of 120° C. or more.

13. The polycarbonate resin composition of claim 2, wherein a content of a polyorganosiloxane portion in the polycarbonate-polyorganosiloxane copolymer is 0.5 to 4 mass %.

14. The polycarbonate resin composition of claim 1, wherein the glass fiber-comprising resin component (A) comprises 5 to 15 mass % of the glass fibers (a2).

15. The polycarbonate resin composition of claim 1, wherein the glass fiber-comprising resin component (A) comprises 5 to 15 mass % of the polymethyl methacrylate resin (a3) component.

16. The polycarbonate resin composition of claim 1, comprising 0.01 to 0.1 parts by mass of the glossy particles (b1), based on 100 parts by mass of the glass fiber-comprising resin component (A).

17. The polycarbonate resin composition of claim 1, comprising 0.05 to 2 parts by mass of the glossy particles (b2), based on 100 parts by mass of the glass fiber-comprising resin component (A).

18. The polycarbonate resin composition of claim 1, wherein the titanium oxide (C) has an average particle diameter of 0.1 to 0.5 μm.

19. The polycarbonate resin composition of claim 1, comprising 0.05 to 0.3 parts by mass of the titanium dioxide (C), based on 100 parts by mass of the glass fiber-comprising resin component (A).
